(19) United States
(12) Patent Application Publication
(10) Pub. No.: US 2015/0347115 A1
(43) Pub. Date: Dec. 3, 2015

(54) SYSTEM AND METHOD FOR MANAGING MULTI-CLOUD DEPLOYMENT

(71) Applicant: SAMSUNG SDS CO., LTD., Seoul (KR)

(72) Inventors: Jeong-Hoon HONG, Seoul (KR); Young-Hwan NAMKOONG, Seoul (KR)

(73) Assignee: SAMSUNG SDS CO., LTD., Seoul (KR)

(21) Appl. No.: 14/725,870

(22) Filed: May 29, 2015

(30) Foreign Application Priority Data
May 30, 2014 (KR) 10-2014-0065545

(51) Int. Cl. G06F 9/445; H04L 29/08

(52) U.S. Cl. CPC G06F 8/61; H04L 67/10

(57) ABSTRACT

A system and method for managing multi-cloud distribution are provided. The system includes a distribution manager installation device configured to install a distribution manager for constructing a cloud computing environment in a target system according to a distribution manager construction request of a user, and control a change of the cloud computing environment constructed in the target system according to a change request of the user; and a distribution management information storage configured to store and manage distribution manager installation information, a server template, a server image, and cloud system configuration information of the target system.

### CROSS-REFERENCE TO RELATED APPLICATION

This application claims priority to and the benefit of Republic of Korea Patent Application No. 10-2014-0065545, filed on May 30, 2014, the disclosure of which is incorporated herein by reference in its entirety.

### BACKGROUND

1. Field

Embodiments of the present disclosure relate to multi-cloud distribution and management technology.

2. Discussion of Related Art

Recently, an effective management of multi-cloud based on a private cloud area by increasing a utilization range of a cloud service has emerged as a major concern.

Accordingly, a multi-cloud platform and a unified cloud distribution and management system capable of effectively managing by integrating various clouds may be needed. However, since conventional systems are limited to Software as a Service (SaaS) based system and service, the management system is exposed to the outside, and there is a limitation when applying a private-based multi-cloud security policy. Further, the conventional system may have a limitation when providing a specialized service for each user of the cloud service, and a problem in which other users are affected when a failure occurs in a portion of a system. Moreover, since there are many cases in which both a resource and service unnecessary for a user environment are collectively provided, there were limitations in which usability is degraded and costs are high.

### SUMMARY

The present disclosure is directed to a system and method for managing multi-cloud distribution in which distribution and management for a construction of a cloud system are automatically performed in a system for managing multi-cloud distribution for providing a personalized cloud computing environment according to a user request.

According to one aspect of the present disclosure, there is provided a system for managing multi-cloud distribution, including: a distribution manager installation device configured to install a distribution manager for constructing a cloud computing environment in a target system according to a distribution manager construction request of a user, and control a change of the cloud computing environment constructed in the target system according to a change request of the user; and a distribution management information storage configured to store and manage distribution manager installation information, a server template, a server image, and cloud system configuration information of the target system.

The distribution manager installation device may include: a resource handler installation module configured to install the distribution manager in the target system according to the distribution manager construction request; a server template installation module configured to provide the server template stored in the distribution management information storage to the distribution manager; and a server image installation module configured to provide the server image stored in the distribution management information storage to the distribution manager.

The distribution manager may include: an orchestration module configured to parse the server template provided from the server template installation module, and construct the cloud computing environment in the target system; a monitoring module configured to collect state information with respect to a resource included in the cloud computing environment; and a repository module configured to store system configuration information with respect to the cloud computing environment, the server template, the server image, and the collected state information.

The distribution management information storage may collect and store the system configuration information stored in the repository module.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram illustrating a configuration of a system 100 for managing multi-cloud distribution according to an exemplary embodiment of the present disclosure;

FIG. 2 is a block diagram illustrating a detailed configuration of a distribution manager 108 according to an exemplary embodiment of the present disclosure; and

FIG. 3 is a block diagram illustrating a detailed configuration of a distribution manager installation device 102 according to an exemplary embodiment of the present disclosure.

### DETAILED DESCRIPTION OF EXEMPLARY EMBODIMENTS

Hereinafter, exemplary embodiments of the present disclosure will be described in detail below with reference to the accompanying drawings. A description described hereinafter is provided to help comprehensive understanding with respect to a method, a device and/or a system described in this specification. However, this is merely to exemplify embodiments, and is not limited thereto.

When describing the exemplary embodiments of the disclosure, when it is determined that a detailed description with respect to known technology related to the disclosure unnecessarily obscures the gist of the present disclosure, a detailed description thereof will be omitted. The terminology used hereinafter is defined in consideration of a function in the exemplary embodiments of the disclosure, and their meaning may be changed according to intentions or customs, etc. of a user, or an operator. Accordingly, the terminology will be defined based on the contents throughout this specification. The terminology used in the detailed description is used for describing the exemplary embodiments of the disclosure, and is not used for limiting the disclosure. Elements of the disclosure referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

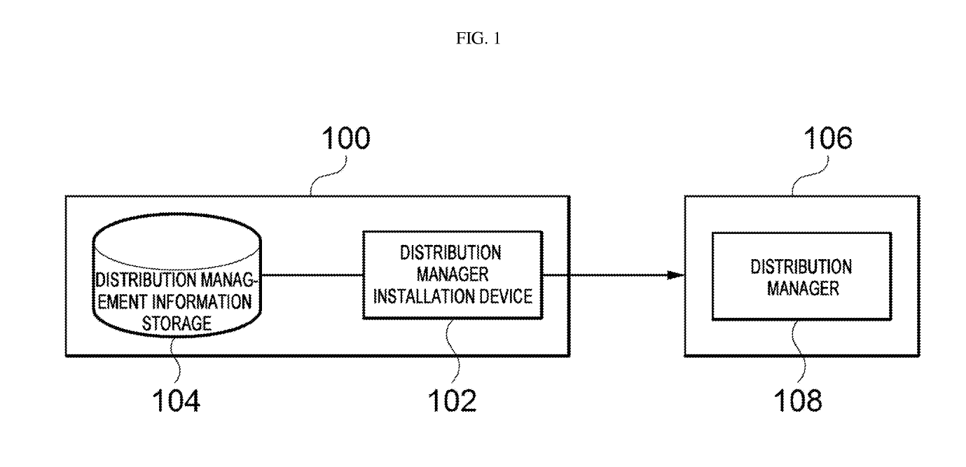

FIG. 1 is a block diagram illustrating a configuration of a system 100 for managing multi-cloud distribution according to an exemplary embodiment of the present disclosure. The multi-cloud distribution management system 100 according to an exemplary embodiment of the present disclosure may be a system for automatically installing a distribution manager 108 in a target system 106. For example, the target system 106 may be a private cloud system in which a business entity, etc. independently constructs for an internal business system.

As shown in FIG. 1, the system 100 for managing multi-cloud distribution according to an exemplary embodiment of the present disclosure may include a distribution manager installation device 102, and a distribution management information storage 104.

The distribution manager installation device 102 may install the distribution manager 108 for constructing a cloud computing environment in the target system 106 according to a distribution manager construction request of a user. The user may be a manager of the target system 106, etc. Further, the distribution manager installation device 102 may control a change of the cloud computing environment configured in the target system 106 according to a change request of the user.

The distribution manager 108 according to an exemplary embodiment of the present disclosure may be a type of software for constructing the cloud computing environment according to the purpose of use of the target system 106. For example, the target system 106 may have a state in which only a cloud platform such as OpenStack™ or CloudStack™, etc. is installed on a plurality of physical servers, in other words, only a basic cloud computing infrastructure is configured. The distribution manager 108 may be installed in the target system 106 having the state, and classify each of the virtual machines included in the target system 106, and assign a function to each of the virtual machines, and construct the cloud computing environment according to the purpose of use of the target system 106 through an operation of installing an operating system and an application on the virtual machine.

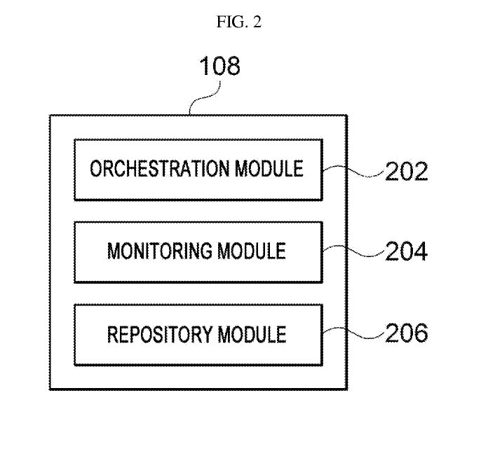

FIG. 2 is a block diagram illustrating a detailed configuration of a distribution manager 108 according to an exemplary embodiment of the present disclosure. As shown in FIG. 2, the distribution manager 108 according to an exemplary embodiment of the present disclosure may include an orchestration module 202, a monitoring module 204, and a repository module 206.

The orchestration module 202 may correspond to a service engine of the distribution manager 108. Particularly, the orchestration module 202 may receive a server template from the distribution manager installation device 102, and construct the cloud computing environment in the target system 106 using the received server template. In an exemplary embodiment, the server template may be construction information for constructing the cloud computing environment suitable for the purpose of the user from the virtual machines such as connection information of each of the virtual machines included in the target system 106, server image information installed on each of the virtual machines, and various types of settings and procedures, etc. for constructing the cloud computing environment. The server template may be provided through a server template installation module 304 in the distribution manager installation device 102 which will be described hereinafter.

The orchestration module 202 may receive the server template described above, parse sequential work information included in the server template, access each virtual machine in the target system 106 based on the work information, and perform operations such as server image installation and setting changes, etc.

Next, the monitoring module 204 may collect state information with respect to each resource in the cloud computing environment configured by the orchestration module 202. For example, the monitoring module 204 may be configured to collect information regarding whether a failure occurs in hardware or software resource of the target system 106, etc. The collected information may be transmitted to a manager of the target system 106 through a visual or auditory element according to an event policy of the target system 106, etc.

The repository module 206 may store system configuration information, a policy, a used server template, and a server image with respect to the cloud computing environment of the target system 106 configured by the orchestration module 202, and the state information collected by the monitoring module 204, etc.

Referring back to FIG. 1, the distribution management information storage 104 may store and manage installation information of the distribution manager 108, the server template, the server image, and the cloud system configuration information of the target system, etc.

The distribution manager installation information may be information which is required when the distribution manager installation device 102 installs the distribution manager 108 in the target system 106, and for example, may include a software package configuring the distribution manager 108 and setting information of the distribution manager 108 for each type of the target system.

The server template and the server image may be a template and an image used when the distribution manager 108 constructs the cloud computing environment in the target system 106. The distribution management information storage 104 may store various types of templates according to the purpose of the service and various virtual images for each operating system used, and a user who desires to construct the cloud computing environment may easily construct the cloud computing environment by selecting a template and an image suitable for herself/himself among the templates and images stored in the distribution management information storage 104.

Further, when the cloud computing environment is constructed in the target system 106, the distribution management information storage 104 may collect cloud system configuration information from the target system 106 and store the collected cloud system configuration information. Particularly, the distribution management information storage 104 may receive the cloud system configuration information from the repository module 206 of the distribution manager 108 installed in the target system 106, and store by backing up the cloud system configuration information. The user may easily copy a system which is previously configured using the system configuration information stored in the distribution management information storage 104 to install a cloud computing system having the same type. This may be useful when installing to extend the cloud computing system installed in one place to another place.

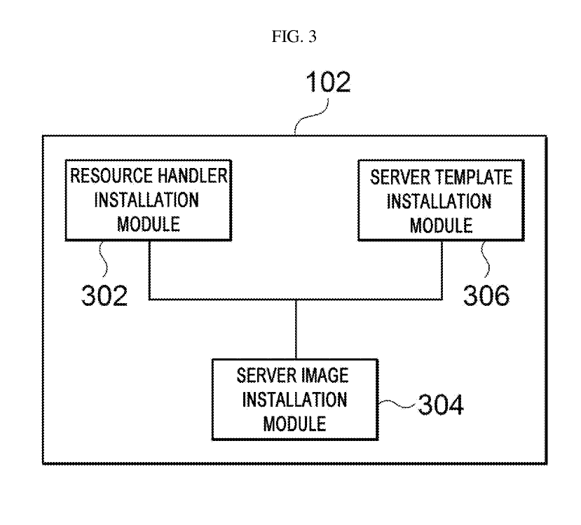

FIG. 3 is a block diagram illustrating a detailed configuration of a distribution manager installation device 102 according to an exemplary embodiment of the present disclosure. As shown in FIG. 3, the distribution manager installation device 102 according to an exemplary embodiment of the present disclosure may include a resource handler installation module 302, a server template installation module 304, and a server image installation module 306.

The resource handler installation module 302 may install the distribution manager 108 in the target system 106 according to a distribution manager construction request from the user. At this time, the resource handler installation module 302 may refer to the distribution manager installation information stored in the distribution management information storage 104.

The server template installation module 304 may provide the server template selected by the user among the server templates stored in the distribution management information storage 104, according to a request of the installed distribution manager 108, to the distribution manager 108.

The server image installation module 306 may provide the server image selected by the user among the server images stored in the distribution management information storage 104, according to a request of the installed distribution manager 108, to the distribution manager 108. At this time, the server image is stored in a form of a file by copying an installation environment of the operating system and the application installed in the server. Thus, the server image is copied to the virtual machine, the virtual machine has a state identical to a state in which the operating system and the application are installed on the virtual machine.

The server template installation module 304 and the server image installation module 306 may provide the server template and the server image which are needed when constructing the cloud computing environment in the target system 106 with the distribution manager 108. Further, even when there is the setting change or an addition request of the user after constructing the cloud computing environment, the server template installation module 304 may provide the server template and the server image corresponding to the change and the addition to the distribution manager 108.

According to embodiments of the present disclosure, the cloud distribution management environment for providing the cloud service may be automatically constructed in the private environment according to the change request of the user. Further, even when there is the cloud computing environment change request of the user, the request can be quickly mirrored, and the cloud system having the same environment can be easily generated by separately storing optimized environment information for each user.

The above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of example embodiments.

Examples of non-transitory computer-readable media include magnetic media such as hard disks, floppy disks, and magnetic tape, optical media such as CD ROM discs and DVDs; magneto-optical media such as optical discs, and hardware devices that are specially configured to store and perform program instructions, such as read-only memory (ROM), random access memory (RAM), flash memory, and the like. The non-transitory computer-readable media may also be a distributed network, so that the program instructions are stored and executed in a distributed fashion. The program instructions may be executed by one or more processors. The non-transitory computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter.

The above-described devices may be implemented using hardware components and software components. For example, the devices included in the multi-cloud distribution management system 100 may be implemented using hardware components. The hardware components may include a processor and a memory.

The processor may be a controller and an arithmetic logic unit, a digital signal processor, a microcomputer, a field programmable array, a programmable logic unit, a microprocessor or any other device capable of responding to and executing instructions in a defined manner such that the processor is programmed with instructions that configure the processing device as a special purpose computer configured to perform the embodiments of the present disclosure.

For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The memory may be any device capable of storing data including magnetic storage, flash storage, etc.

It will be apparent to those skilled in the art that various modifications can be made to the above-described exemplary embodiments of the present disclosure without departing from the spirit or scope of the disclosure. Thus, it is intended that the present disclosure covers all such modifications provided they come within the scope of the appended claims and their equivalents.

What is claimed is:

1. A system for managing multi-cloud distribution, comprising:
a distribution manager installation device configured to install a distribution manager for constructing a cloud computing environment in a target system according to a distribution manager construction request of a user, and control a change of the cloud computing environment constructed in the target system according to a change request of the user; and
a distribution management information storage configured to store and manage distribution manager installation information, a server template, a server image, and cloud system configuration information of the target system.

2. The system of claim 1, wherein the distribution manager installation device includes:
a resource handler installation module configured to install the distribution manager in the target system according to the distribution manager construction request;
a server template installation module configured to provide the server template stored in the distribution management information storage to the distribution manager; and
a server image installation module configured to provide the server image stored in the distribution management information storage to the distribution manager.

3. The system of claim 2, wherein the distribution manager includes:
an orchestration module configured to parse the server template provided from the server template installation module, and construct the cloud computing environment in the target system;
a monitoring module configured to collect state information with respect to a resource included in the cloud computing environment; and
a repository module configured to store system configuration information with respect to the cloud computing environment, the server template, the server image, and the collected state information.

4. The system of claim 3, wherein the distribution management information storage collects and stores the system configuration information stored in the repository module.
